(19) United States
(12) Patent Application Publication
(10) Pub. No.: US 2011/0240777 A1
(43) Pub. Date: Oct. 6, 2011

(54) MOTOR VEHICLE FOR COLLECTING PAPER

(75) Inventors: Justin Johns, Hamilton (CA); David Yamamoto, Paris (CA); Allen Petten, Cambridge (CA); Derek Pepino, Cambridge (CA); Sid Vandermeulen, Kitchener (CA)

(73) Assignee: Shred-Tech Corporation

(21) Appl. No.: 12/749,936

(22) Filed: Mar. 30, 2010

(51) Int. Cl. B02C 23/00; B60P 1/00; B60P 1/04; B65F 3/26

(52) U.S. Cl. 241/101.71; 414/540; 414/469

(57) ABSTRACT

A motor vehicle collects paper. The motor vehicle includes a collection compartment configured to receive the paper. It also includes at least one of a bin lifting device configured to lift a bin to deposit the paper in the collection compartment and a moving floor configured to transport the paper within the collection compartment. The motor vehicle further includes at least one battery disposed within or attached to the collection compartment configured to power an actuator for at least one of the bin lifting device and the moving floor.

### BACKGROUND

1. Field of Embodiments

The disclosed embodiments relate generally to a motor vehicle for collecting paper.

2. Description of Related Art

Trucks often are used to collect large amounts of paper from commercial or residential buildings and transport the paper to a shredding site, where the paper is unloaded and shredded for recycling or other purposes. Such trucks typically use on-board auxiliary equipment to load and unload the paper. Often, that auxiliary equipment is driven by actuators, which in turn are powered by a hydraulic pump connected by a power take-off to an internal combustion engine that also provides motive power for the truck. Consequently, the actuators are only capable of driving the auxiliary equipment when the truck engine is running.

Disadvantages result from the need to keep the truck engine running to load and unload the paper. For example, the operator(s) performing the loading and unloading of the truck, as well as anyone else standing near the truck, likely will inhale exhaust fumes. As another example, leaving the engine idling during loading and unloading of the paper increases fuel consumption and increases the output of exhaust gases to the atmosphere. As yet another example, running of the truck engine may be prohibited while the truck is within a building, thus requiring the truck to be positioned outside the building during the loading process. Consequently, the paper must be brought outside the building for loading, which can increase the time needed to load paper into the truck. As yet another example, the sound generated by the running engine may be objectionable or even prohibited in certain locations.

A need exists for improved technology, including technology that may address one or more of the above-described disadvantages of conventional trucks.

### SUMMARY

One embodiment relates to a motor vehicle for collecting paper. The motor vehicle includes a collection compartment configured to receive the paper. It also includes at least one of a bin lifting device configured to lift a bin to deposit the paper in the collection compartment and a moving floor configured to transport the paper within the collection compartment. The motor vehicle further includes at least one battery disposed within or attached to the collection compartment configured to power an actuator for at least one of the bin lifting device and the moving floor.

### BRIEF DESCRIPTION OF THE DRAWINGS

These and other features, aspects, and advantages of the disclosed embodiments will become apparent from the following description, appended claims, and the accompanying exemplary embodiments shown in the drawings, which are briefly described below.

FIG. 1 is a side view of an embodiment of a collection truck.

FIG. 2 is a rear view of the collection truck of FIG. 1.

FIG. 3 is a top rear perspective view of the collection truck of FIG. 1.

FIG. 4 is a detail view of section A of FIG. 3.

FIG. 5 is a schematic diagram of an embodiment of components for powering auxiliary equipment in the collection truck of FIG. 1.

FIG. 6 is a schematic diagram of an alternative embodiment of components for powering auxiliary equipment in the collection truck of FIG. 1.

FIG. 7 is a side view of another embodiment of a collection truck with a dumping device in a discharge position.

FIG. 8 is a rear view of another embodiment of a dumping device of a collection truck.

FIG. 9 is a side view of another embodiment of a collection truck with a shredder mechanism.

### DETAILED DESCRIPTION OF THE PREFERRED EMBODIMENTS

Presently preferred embodiments are illustrated in the drawings. An effort has been made to use the same or like reference numbers throughout the drawings to refer to the same or like parts. Although the specification refers primarily to a collection truck, it should be understood that the subject matter described herein is applicable to motor vehicles in general.

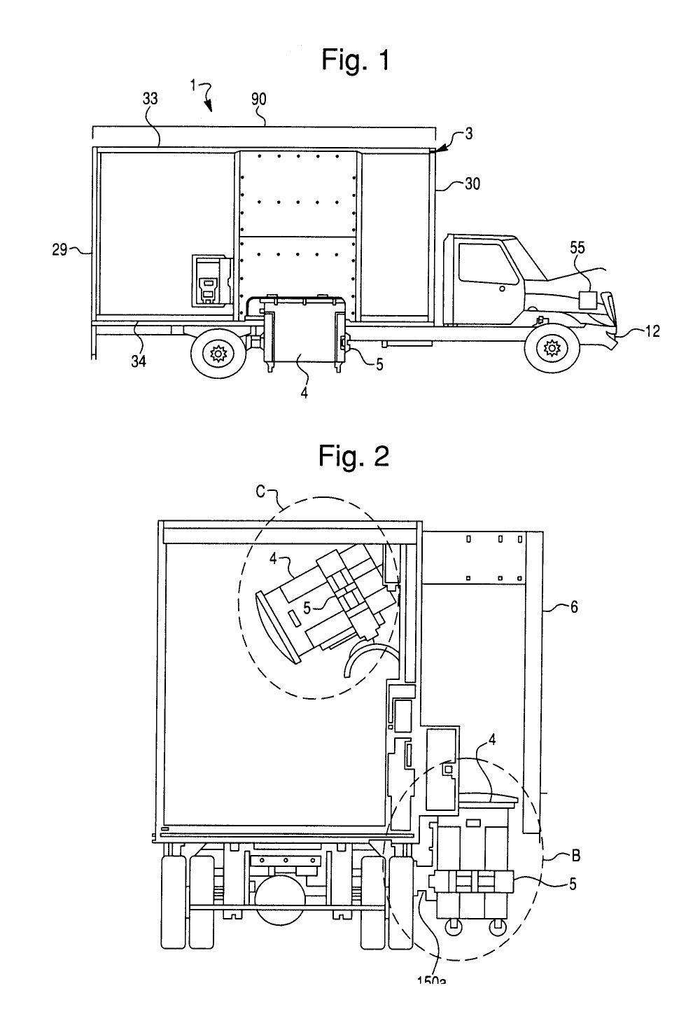

FIGS. 1-6 illustrate an embodiment of a motor vehicle 1, e.g., a truck, for collecting paper. The motor vehicle 1 may be any vehicle capable of transporting paper from a first location to a second location. Preferably, the motor vehicle is a truck. The first location can be, for example, an office building (not shown) from which the paper is received. The second location can be, for example, a shredding facility (not shown) that is capable of shredding the paper.

The motor vehicle 1 may include a collection compartment 3, auxiliary equipment, and at least one battery 8 for powering actuator(s) for driving the auxiliary equipment. The auxiliary equipment may include at least one of a bin lifting device 5 and a moving floor 7. The motor vehicle 1 preferably also includes a chassis 12, which can form the frame of the motor vehicle 1 to hold the various components, and a primary mover, e.g., an internal combustion engine 55, to propel the motor vehicle 1.

The collection compartment 3 is configured to receive and hold paper loaded into the motor vehicle 1. The collection compartment 3 may include one or more sub-compartments for receiving paper. The motor vehicle 1 also may include additional compartments that serve different purposes. For example, the motor vehicle may have a general storage area 90 that includes the collection compartment 3 for receiving the loaded paper and another compartment used, for example, for storing shredded paper or other materials.

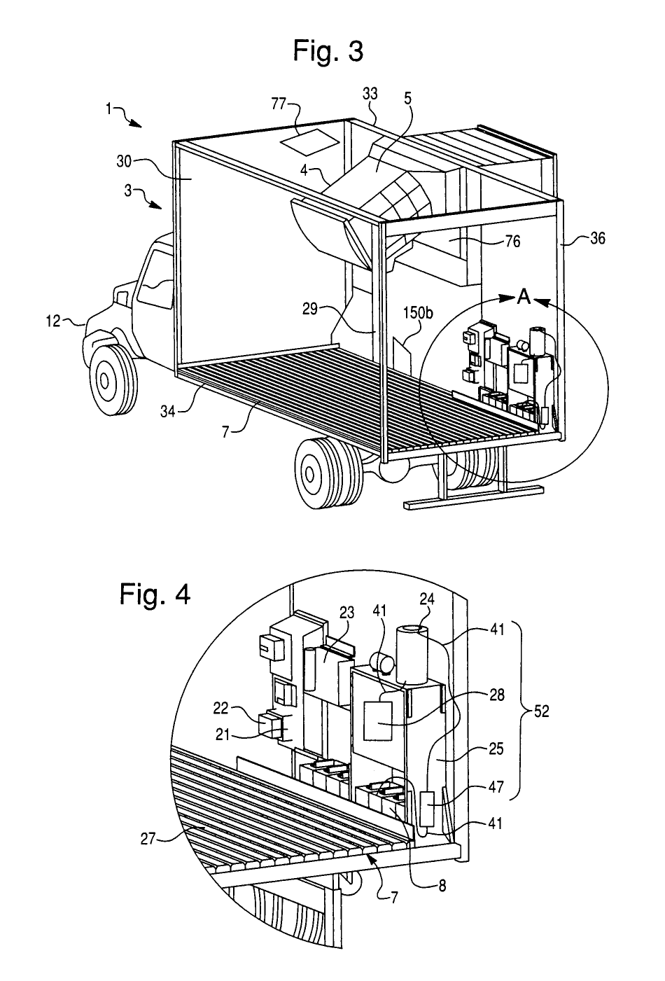

The collection compartment 3 preferably includes a back wall 29, a front wall 30, a top wall 33, a bottom wall or floor 34, and two side walls 35, 36. The collection compartment 3 can include one or more openings 76, 77 to allow paper outside the motor vehicle 1 to be loaded into the interior of the collection compartment 3. Preferably, the opening 76 is located in one of the side walls, e.g., side wall 36 as shown in FIG. 3. The opening could be provided in alternative or additional locations, such as the opening 77 in the top wall 33 of the collection compartment 3. In addition, the collection compartment 3 preferably is configured to allow easy discharge of the paper from the collection compartment 3. For example, the back wall 29 can be configured to be opened or can include a door or hatch (not shown) that can be opened to allow paper to be discharged from the collection compartment 3. Any suitable mechanism may be used to open the back wall 29 or the door or hatch in the back wall 29. Alternatively, they could be manually opened by an operator.

The auxiliary equipment can be used to deposit paper into the collection compartment 3, transport paper within the collection compartment 3, and/or discharge paper from the collection compartment 3. However, it is not required that the auxiliary equipment perform all of these functions, as one or more of the functions could be performed manually or through other means.

The bin lifting device 5 is configured to deposit paper into the collection compartment 3 by lifting a bin 4 at least partially filled with paper and discharging that paper into the collection compartment 3. The bin lifting device 5 lifts the bin 4 from the outside of the collection compartment 3 and inserts it at least partially within the inside of the collection compartment 3 through the opening 76. While lifting the bin 4 into the collection compartment 3, the bin lifting device 5 tips the bin 4, thereby causing any paper located in the bin 4 to discharge into the collection compartment 3. After loading the paper into the collection compartment 3, the bin lifting device 5 retracts the bin 4 and places the bin 4 outside of the collection compartment 3.

The bin lifting device 5 may be any suitable mechanism. For example, as shown in FIG. 2, the bin lifting device 5 may be a gripper 5 having two gripping arms. Circle B of FIG. 2 shows the gripper 5 holding the bin 4 before the paper is loaded into the collection compartment 3. Circle C of FIG. 2 shows the hydraulic gripper 5 holding the bin 4 as the paper in the bin 4 is loaded into the collection compartment 3. Another example (not shown) of a bin lifting device 5 includes a pair of guide rails integrated with a pair of chains, where the chains operate to drive a carriage that is coupled to the bin 4 to move it from outside of the collection compartment 3 to inside of the collection compartment 3. Such a bin lifting device 5 is described in U.S. Pat. No. 7,211,747, filed on Aug. 25, 2004, which is incorporated herein by reference in its entirety. The bin lifting device 5 can be configured to unload paper from one bin 4 at a time or from multiple bins 4 simultaneously.

The bin lifting device 5 can be driven by an actuator 150a. Any suitable actuator 150a may be used to drive the bin lifting device 5. Preferably, the actuator 150a is one of a hydraulic device and an electric motor. Exemplary hydraulic devices include, but are not limited to, a hydraulic cylinder and a hydraulic motor. Commercially available electric hydraulic pumps supplying sufficient horsepower could be used. Preferably, the bin lifting device 5 is configured to unload bin(s) 4 with a weight of approximately 750 lbs. within a cycle time of 20 seconds.

An enclosure 6 preferably is provided to prevent an operator from being caught in the bin lifting device 5 or bin 4 during loading and unloading of the paper and to protect the paper from being exposed to the environment. The enclosure 6 may cover both the bin lifting device 5 and the opening 76 in the collection compartment 3. The enclosure 6 is typically three sided. The actual size of the enclosure 6 is determined by total size of the bin(s) 4 to be unloaded, the size of the bin lifting device 5, and desired amount of coverage of bin(s) 4 and bin lifting device 5. The enclosure 6 can be a conventional mechanism that is extended from the side of the collection compartment 3 during the unloading of the bin(s) 4 and retracted back into the side of collection compartment 3 after the bin(s) 4 have been unloaded. When the enclosure 6 is retracted, the width of the motor vehicle 1 is a legal width for travel on public roads. Any suitable mechanism can be used to cause the enclosure 6 to extend from and retract into the side of the collection compartment 3. For example, the enclosure 6 may be pushed in and out of the collection compartment 3 by hand or by a rail system. An example of such an enclosure 6 may be found in U.S. Pat. No. 6,588,691, filed on Aug. 31, 2001, which is incorporated herein by reference in its entirety.

The moving floor 7 is configured to transport the paper within the collection compartment 3. For example, the moving floor 7 can transport the paper loaded into the collection compartment 3 from the loading location near the front wall 30 to a more rearward location in the collection compartment 3. By moving the paper rearward, clearance is provided to allow for the loading of additional paper into the collection compartment 3. As a further example, the moving floor 7 can be configured to assist in unloading the paper from the collection compartment 3. In particular, the moving floor 7 can be used to move the paper toward the opening or exit from the collection compartment 3 to discharge the paper from the collection compartment.

The moving floor 7 can be any suitable mechanism. As shown in FIGS. 3 and 4 for example, the moving floor 7 may include a plurality of axially extending, parallel slats 27. The parallel slats 27 may be arranged in groups, where each of the parallel slats 27 making up a group are fixed together so that they move in the same direction and at the same time as all of the other slats in their group. An exemplary moving floor 7 including separately grouped slats 27 is described in U.S. application Ser. No. 11/685,925, filed on Mar. 14, 2006, which is incorporated herein by reference in its entirety. Alternatively, the moving floor 7 may include one or more conveyor belts driven by one or more actuators 150b (not shown).

The moving floor 7 can be driven by an actuator 150b, which is shown schematically in FIG. 3. Any suitable actuator 150b, such as one of a hydraulic device and an electric motor, may be used to drive the moving floor 7. Preferably, the actuator 150b is a hydraulic device such as a hydraulic cylinder or a hydraulic motor.

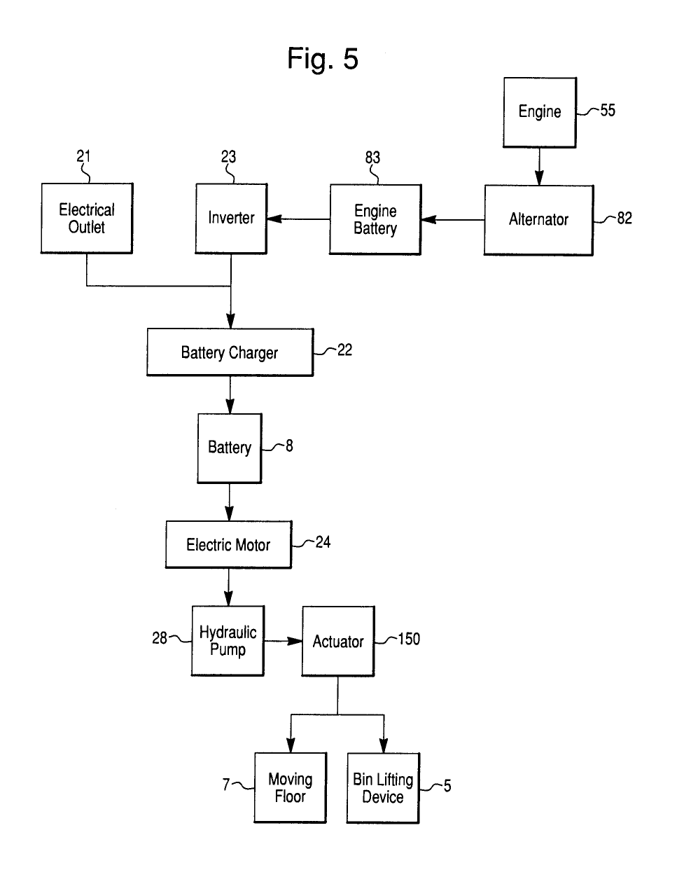

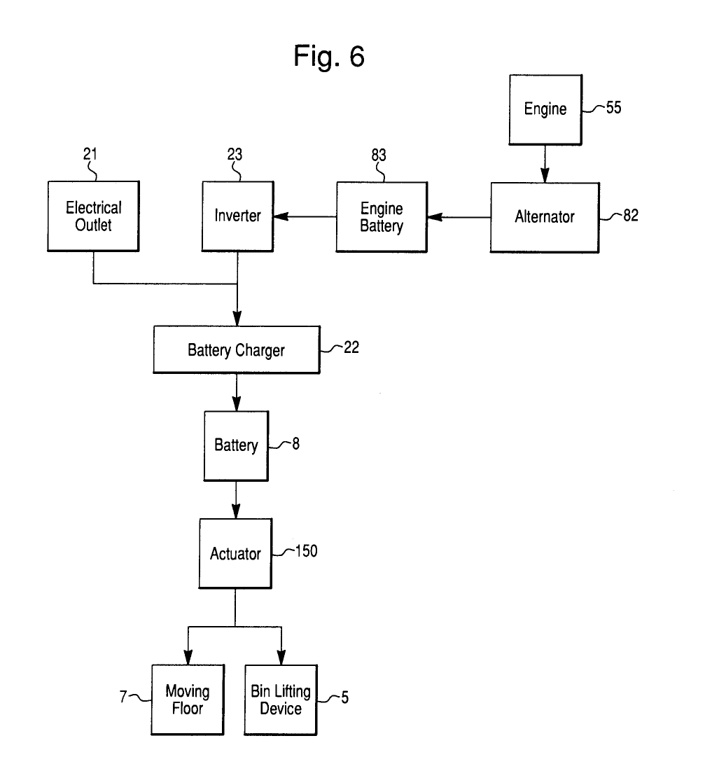

The at least one battery 8 is shown in FIG. 4 and is configured to directly or indirectly power the actuators power the actuators 150a, 150b of the auxiliary equipment described above. The at least one battery 8 will hereinafter be referred to simply as the battery 8 for ease description, unless it is necessary to refer to individual batteries. Additionally, the separate actuators 150a, 150b are represented generically by the reference numeral 150 in FIGS. 5-6 for ease of illustration.

The battery 8 can be configured to indirectly power any suitable actuator 150. For example, if the actuator 150 is a hydraulic device, a drive mechanism 52 can be provided to convert the electrical energy of the battery 8 into hydraulic force that can drive the hydraulic actuator 150. As shown in FIG. 5, the drive mechanism 52 may include an electric motor 24 and a hydraulic pump 28.

A specific example of such a configuration is shown in FIG. 4. The battery 8 is connected by a suitable connector 41 to provide electrical power to the electric motor 24. The electric motor 24 may be any suitable type of electric motor, but preferably is a brush type series wound DC motor capable of 8 nominal horsepower and 20 peak horsepower. The electric motor 24 in turn is connected by another suitable connector 41 to provide force to the hydraulic pump 28. The hydraulic pump 28 preferably includes in a reservoir 25 containing a biodegradable synthetic hydraulic fluid. The use of biodegradable synthetic hydraulic fluid decreases the likelihood that harmful material will be discharged from the motor vehicle 1. Biodegradable synthetic hydraulic fluid is also beneficial because it may permit immediate cold operation and dispense with the need for warm-up. The speed of the electric motor 24 may be controlled by an electronic speed control module 47, which allows for control over the speed of the actuator 150.

As an optional alternative embodiment, the battery 8 can also be configured to directly power any actuator 150 that is capable of being driven by electric power. For example, if the actuator 150 is an electric motor, the battery 8 can be connected by suitable structure to the actuator 150 to power that actuator, as shown schematically in FIG. 6.

Any amount of batteries 8 can be used that are capable of providing enough power to the actuator 150 to drive auxiliary equipment. Typically, a plurality of batteries 8 will be used. The batteries 8 may be positioned in any suitable configuration if more than one battery 8 is used to power the actuator 150. Preferably, if there are a plurality of batteries 8, the batteries 8 are grouped in banks of four. Each of the batteries 8 making up a bank of batteries 8 is connected to each other in series. Each bank of batteries 8 is connected to another bank of batteries 8 in parallel. Connecting the batteries 8 in each bank of batteries 8 in series and connecting each bank of batteries 8 to each other in parallel provides a compact power supply that is capable of delivering sufficient current. Any suitable battery 8 may be used. Preferably each individual battery 8 is a 12 Volt Gel type sealed lead-acid battery. Alternatively the battery 8 could be a battery optima SC340 12 Volt, 55 Ampere battery.

The battery 8 may be located in any suitable location within or attached to the collection compartment 3. For example, the battery 8 may be located in the collection compartment 3, as shown in FIGS. 3 and 4, or coupled to chassis 12 of the motor vehicle 1 (not shown).

The battery 8 may be charged (including re-charge) in one or more ways. Different charging configurations are illustrated schematically in FIGS. 5 and 6. The motor vehicle 1 may employ one or more of these configurations.

For example, the battery 8 could be charged by plugging a cord into an electrical outlet 21. The electrical energy from the outlet 21 is provided to a battery charger 22, which charges the battery 8. The battery 8 may be charged by the electrical outlet 21 when the engine 55 of the motor vehicle 1 is running or not running. This configuration allows for the battery 8 to be charged at a home location, a worksite, or any location in between.

The battery 8 also could be charged by an inverter 23 that connects to an engine battery 83 that is recharged by an alternator 82 connected to the engine 55. The inverter 23 may be any suitable inverter 23, for example a 2000 Watt marine power inverter or a 1500 Watt 12 Volt inverter with cables. This configuration is advantageous because it allows the battery 8 to be charged even if an outlet is not available. For example, it would allow for charging of the battery 8 while the motor vehicle 1 is traveling to a location.

In the above-described configurations, the battery charger 22 may be any suitable battery charger 22. For example, the battery charger 22 may be a 48 Volt output and 25 Ampere with 110 Volt input or a 48 Volt output and 15 Ampere with 110 Volt input.

The ability of the battery 8 to power the auxiliary equipment without the motor vehicle running can provide many advantages. For example, the motor vehicle 1 will output no exhaust fumes into the environment during loading and unloading. Additionally, use of the battery 8 can eliminate the noise of an idling engine 55.

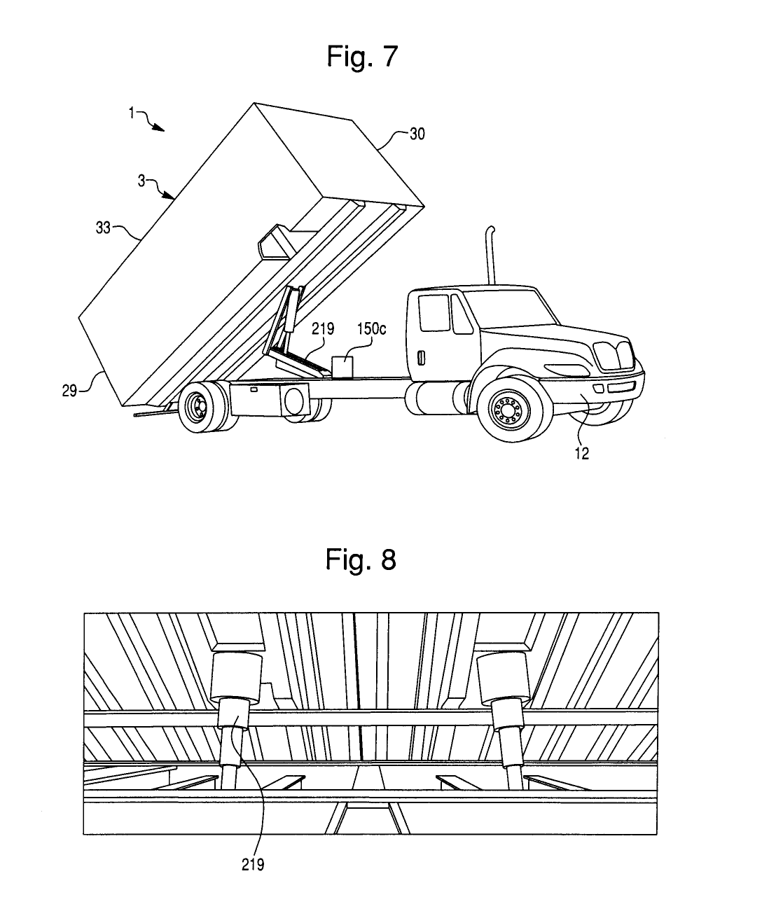

An alternative embodiment is shown in FIGS. 7 and 8. In this embodiment, the motor vehicle 1 may also include a dumping device 219 that is configured to discharge the paper from the collection compartment 3. The dumping device 219 preferably is configured to raise a portion of the collection compartment 3 to cause the paper to move out of the collection compartment due to gravitational force. For example, the dumping device 219 may be a hydraulically driven lifting device 219 that lifts only the front end 30 of the collection compartment 3 to a desired vertical height. Exemplary hydraulically driven lifting devices may include a scissor lift 219 (see FIG. 7) or two single acting telescopic cylinders 219 (see FIG. 8).

Much like the bin lifting device 5 and the moving floor 7, shown in FIGS. 1-6, the dumping device 219 may be driven by an actuator 150c, which is shown schematically in FIG. 7, that is powered by a battery 8. The actuator 150c may be any suitable device, such as one of a hydraulic device and an electric motor. Preferably, the actuator 150c is a hydraulic device.

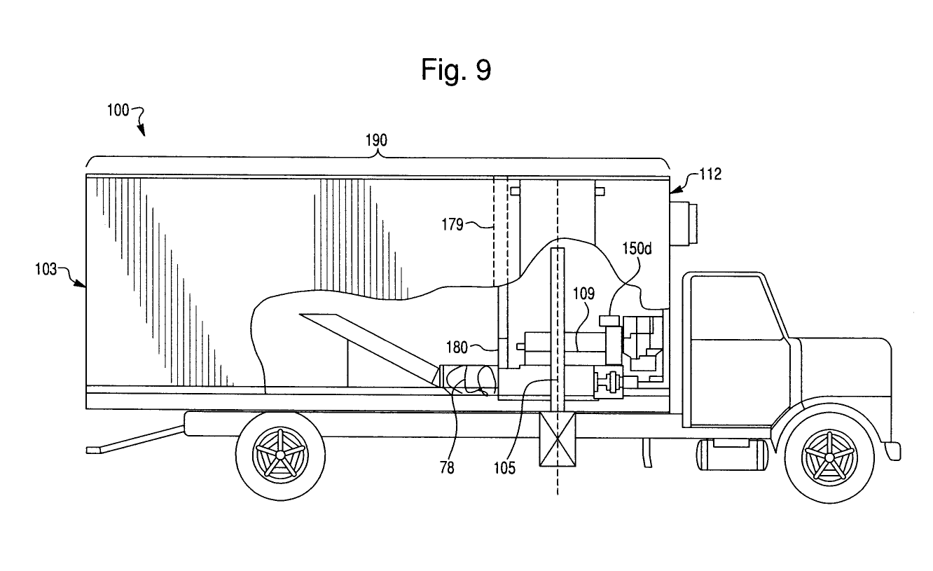

An alternative embodiment is shown in FIG. 9. In this embodiment, the motor vehicle 1 may also include a shredder mechanism 109 that is configured to shred paper. For example, the shredder mechanism 109 may be a ST-15 shredder. The motor vehicle can have a storage compartment 190 that includes both a shredding compartment 112 and a collection compartment 103, which may be separated by any suitable divider 179. The shredder mechanism 109 can be located in the shredding compartment 112. The shredding compartment 112 provides a holding space for paper that is to be shredded by the shredder mechanism 109. Once the paper is shredded by the shredder mechanism 109, the shredded paper enters the collection compartment 103. The collection compartment 103 provides a holding space for the shredded paper. The shredded paper may be transported to the collection compartment 103 via any suitable mechanism. For example, an auger 78 may transport the shredded paper from the shredding compartment 112 to the collection compartment 103 through an opening 180 in the divider 179. Any suitable auger 78 may be used.

Much like the bin lifting device 5, the moving floor 7, and the dumping device 219, shown in FIGS. 1-8, the shredder mechanism 109 may be driven by an actuator 150d that is powered by the battery 8. The actuator 150d may be any suitable actuator. Preferably the actuator 150 is an electric motor or a hydraulic device.

One versed in the art would appreciate that there may be other embodiments and modifications within the scope and spirit of the disclosure. Accordingly, all modifications attainable by one versed in the art from the present disclosure, within its scope and spirit, are to be included as further embodiments of the present disclosure. The scope of the following claims and their equivalents is intended to cover such embodiments, modifications, and alternative designs.

What is claimed is:

1. A motor vehicle for collecting paper, comprising:
a collection compartment configured to receive the paper;
at least one of:
a bin lifting device configured to lift a bin to deposit the paper in the collection compartment; and
a moving floor configured to transport the paper within the collection compartment; and
at least one battery disposed within or attached to the collection compartment configured to power an actuator for at least one of the bin lifting device and the moving floor.

2. The motor vehicle of claim 1, wherein the bin lifting device lifts the bin and the paper to move the bin and the paper from outside of the collection compartment to inside of the collection compartment.

3. The motor vehicle of claim 1, wherein the moving floor transports the paper within the collection compartment.

4. The motor vehicle of claim 1, wherein the moving floor discharges the paper from the collection compartment.

5. The motor vehicle of claim 1, wherein the actuator is one of a hydraulic device and an electric motor.

6. The motor vehicle of claim 1, further comprising a battery charger configured to charge the battery.

7. The motor vehicle of claim 6, wherein the battery charger is configured to be connected to an electrical outlet.

8. The motor vehicle of claim 6, wherein the battery charger is connected to an inverter.

9. The motor vehicle of claim 8, wherein the inverter is connected to an engine battery that is recgharged by an alternator from an engine of the motor vehicle.

10. The motor vehicle of claim 1, further comprising a dumping device configured to discharge the paper from the collection compartment, wherein the at least one battery is configured to power an actuator for the dumping device.

11. The motor vehicle of claim 10, wherein the dumping device tilts the collection compartment to discharge the paper from the collection compartment.

12. The motor vehicle of claim 1, further comprising a shredder mechanism configured to shred the paper received in the collection compartment.
